(19) United States
(12) Patent Application Publication
(10) Pub. No.: US 2025/0142658 A1
(43) Pub. Date: May 1, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/834,713

(22) PCT Filed: Feb. 11, 2022
(86) PCT No.: PCT/CN2022/076100

§ 371 Date: Jul. 31, 2024

(51) Int. Cl. H04W 76/19; H04W 28/06; H04W 74/0833; H04W 76/18

(52) U.S. Cl. CPC H04W 76/19; H04W 28/06; H04W 74/0833; H04W 76/18

(57) ABSTRACT

Embodiments of the present disclosure relate to methods, devices and computer readable media for communication. The method comprises if receiving, at a terminal device and from a network device, a connection reject message while the terminal device is performing a first connection resume procedure initiated for small data transmission (SDT); and initiating a second connection resume procedure. In this way, the SDT procedure can be rejected in case of network congestion.

### TECHNICAL FIELD

Embodiments of the present disclosure generally relate to the field of telecommunication, and in particular, to methods, devices and computer storage media of communication during data transmission in an inactive state of a terminal device.

### BACKGROUND

Typically, a terminal device in an inactive state may still have small and infrequent data traffic to be transmitted. Until the third generation partnership project (3GPP) Release 16, the inactive state cannot support data transmission, and the terminal device has to resume connection (i.e., enter a connected state) for any downlink and uplink data. This will result in unnecessary power consumption and signaling overhead.

In this event, 3GPP Release 17 has approved small data transmission (SDT) in the inactive state. Thereby, the signaling overhead can be reduced. However, up to now, SDT-related techniques are still incomplete and to be further developed.

### SUMMARY

In general, embodiments of the present disclosure provide methods, devices and computer storage media for communication.

In a first aspect, there is provided a method of communication. The method comprises: receiving, at a terminal device and from a network device, a connection reject message while the terminal device is performing a first connection resume procedure initiated for small data transmission (SDT); and initiating a second connection resume procedure.

In a second aspect, there is provided a method of communication. The method comprises: transmitting, at a terminal device and to a network device, a message on SRB1 indicating arrival of non-SDT data while performing a SDT procedure; in response to receiving, from the network device, a connection reject message continuing the SDT procedure.

In a third aspect, there is provided a method of communication. The method comprises: transmitting, at a network device and to a terminal device, a connection reject message as a response to a first connection resume procedure initiated for SDT; receiving a connection resume request message for a second connection resume procedure not initiated for SDT; and transmitting, a connection setup message.

In a fourth aspect, there is provided a method of communication. The method comprises: initiating, at a terminal device, configured grant based SDT procedure; determining that there is no Synchronization Signal Block (SSB) associated with the configured grant resources for SDT is above a threshold; determining that a Buffer Status Report (BSR) is triggered or there is buffered data to be transmitted; and initiating one random access procedure.

In a fifth aspect, there is provided a terminal device. The terminal device comprises a processor and a memory coupled to the processor. The memory stores instructions that when executed by the processor, cause the terminal device to perform the method according to any of the first to second aspects of the present disclosure.

In a sixth aspect, there is provided a network device. The network device comprises a processor and a memory coupled to the processor. The memory stores instructions that when executed by the processor, cause the network device to perform the method according to the third aspect of the present disclosure.

In a seventh aspect, there is provided a computer readable medium having instructions stored thereon. The instructions, when executed on at least one processor, cause the at least one processor to perform the method according to any of the first to second aspects of the present disclosure.

In an eighth aspect, there is provided a computer readable medium having instructions stored thereon. The instructions, when executed on at least one processor, cause the at least one processor to perform the method according to the third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane (UP) protocol stack in which some embodiments of the present disclosure can be implemented;

FIG. 1C illustrates a schematic diagram of a control plane (CP) protocol stack in which some embodiments of the present disclosure can be implemented;

FIG. 2A illustrates a schematic diagram illustrating a SDT procedure in which some embodiments of the present disclosure can be implemented;

FIG. 2B illustrates a schematic diagram illustrating a SDT procedure comprising initial transmission and subsequent transmission in which some embodiments of the present disclosure can be implemented;

FIG. 3 illustrates a schematic diagram illustrating a process for communication during a SDT procedure according to embodiments of the present disclosure;

FIG. 4 illustrates a schematic diagram illustrating a process for communication during a SDT procedure according to embodiments of the present disclosure;

FIG. 5 illustrates an example method of communication implemented at a terminal device in accordance with some embodiments of the present disclosure;

FIG. 6 illustrates an example method of communication implemented at a terminal device in accordance with some embodiments of the present disclosure;

FIG. 7 illustrates an example method of communication implemented at a network device in accordance with some embodiments of the present disclosure;

FIG. 8 illustrates an example method of communication implemented at a network device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Currently, there are various applications that involve exchange of small and infrequency data. For example, in some applications of mobile devices, SDT may involve traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may involve sensor data (e.g., temperature, pressure readings transmitted periodically or in an event-triggered manner in an IoT network), metering and alerting information sent from smart meters, and/or the like.

In legacy RRC resume procedure, no uplink data are transmitted for the inactive state terminal device together with the RRC resume request message. While for SDT procedure, uplink data can be transmitted for the inactive state terminal device together with RRC resume request message to the network device.

During a SDT, uplink data from at least one of radio bearers supporting transmission in inactive state is transmitted in an inactive state of a terminal device. Whether one radio bearer supporting data transmission in inactive state is configured by the network device. In some scenarios, there may be new data (for convenience, also referred to as non-SDT data herein) arriving from radio bearers not supporting transmission in inactive state during the SDT.

For the above or other potential scenarios, embodiments of the present disclosure provide improved solutions of communication during a SDT, in order to make sure that the SDT can be finished as soon as possible. Principles and implementations of the present disclosure will be described in detail below with reference to the figures.

### Example of Communication Environment

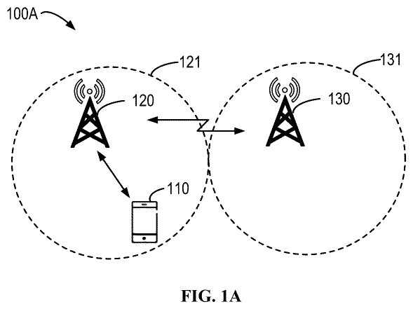

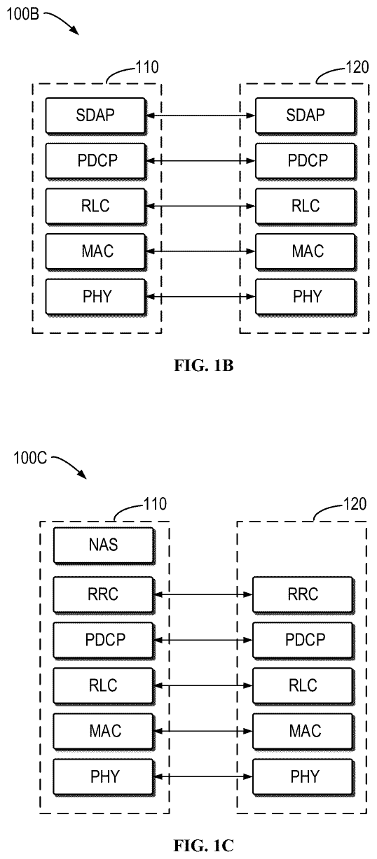

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130. The network devices 120 and 130 provide respective cells 121 and 131. In the example of FIG. 1A, the terminal device 110 is located within the cell 121 of the network device 120, and the terminal device 110 may communicate with the network device 120. The cell 121 may be referred to as a serving cell of the terminal device 110.

It is to be understood that the number of devices in FIG. 1A is given for the purpose of illustration without suggesting any limitations to the present disclosure. The communication network 100 may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some scenarios of dual connection, the network device 120 and 130 may serve the terminal device 110 simultaneously as a master node (MN) or a secondary node (SN). The cells provided by the MN form a master cell group (MCG) for the terminal device 110, and the cells provided by the SN form a secondary cell group (SCG) for the terminal device 110. In some scenarios, the terminal device 110 in an inactive state may communicate with the network device 120 or 130.

Communication in a direction from the terminal device 110 towards the network device 120 or 130 is referred to as uplink (UL) communication, while communication in a reverse direction from the network device 120 or 130 towards the terminal device 110 is referred to as downlink (DL) communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100 can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH), and a random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. In the context of the present disclosure, a DRB may be configured as supporting transmission in inactive state (i.e. supporting SDT). Of course, a DRB may also be configured as not supporting transmission in inactive state (i.e. not supporting SDT). A SRB may be configured as supporting SDT. Of course, a SRB may also be configured as not supporting SDT.

Three types of SRBs are defined in a RRC layer, i.e., SRB0, SRB1 and SRB2. SRB0 uses a CCCH for RRC connection establishment, resume or reestablishment. SRB1 uses a DCCH and is established when RRC connection is established. SRB2 uses a DCCH and is established during RRC reconfiguration and after initial security activation.

In addition, a protocol data unit (PDU) session may be established at the NAS layer of the terminal device 110 to transmit data to CN or receive data from CN. A PDU session may correspond to a SDAP entity, and may comprise a plurality of quality of service (QOS) flows. In the context of the present disclosure, a QoS flow may be configured as supporting SDT. Of course, a QoS flow may also be configured as not supporting SDT.

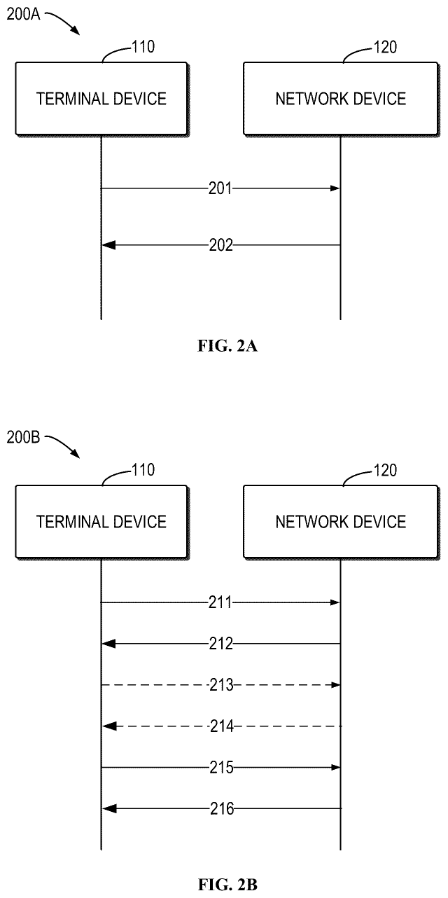

In the context of the present disclosure, the terminal device 110 in an inactive state may communicate with the network device 120. In some scenarios, when the terminal device 110 has small and infrequency data traffic from radio bearer supporting SDT to be transmitted, the terminal device 110 may initiate a SDT procedure. FIG. 2A illustrates a schematic diagram illustrating a SDT procedure 200A for one-shot in which some embodiments of the present disclosure can be implemented. As shown in FIG. 2A, the terminal device 110 in an inactive state may transmit 201, to the network device 120, a RRC resume request with UL data associated with the data traffic. For example, the terminal device 110 may transmit the RRC resume request with UL data in Msg A of a 2-step random access procedure or in Msg3 of a 4-step random access procedure. Of course, the terminal device 110 may also transmit the RRC resume request with UL data in a configured grant (CG) resource. The RRC resume request may comprise a resume cause. Upon receipt of the RRC resume request and the UL data, the network device 120 may transmit 202 a RRC release message with DL data corresponding to the UL data to the terminal device 110. For example, the network device 120 may transmit the RRC release message with the DL data in Msg B of a 2-step random access procedure or in Msg4 of a 4-step random access procedure. Or the network device 120 may transmit the RRC release message with DL data as a response to the transmission at the CG resource. So far, the SDT procedure 200A ends.

FIG. 2B illustrates a schematic diagram illustrating a SDT procedure 200B comprising initial transmission and subsequent transmission in which some embodiments of the present disclosure can be implemented. As shown in FIG. 2B, the terminal device 110 in an inactive state may transmit 211, to the network device 120, a RRC resume request with UL data and a BSR. For example, the terminal device 110 may transmit the RRC resume request with the UL data and the BSR in Msg A of a 2-step random access procedure or in Msg3 of a 4-step random access procedure. Of course, the terminal device 110 may also transmit the RRC resume request with UL data in a configured grant (CG) resource. The RRC resume request may comprise a resume cause. Upon receipt of the RRC resume request with the UL data and the BSR, the network device 120 may transmit 212 an indication of subsequent transmission to the terminal device 110. For example, the network device 120 may transmit an explicit RRC message indicating the subsequent transmission. As another example, the network device 120 may transmit an UL grant for further transmission so as to implicitly indicate the subsequent transmission. In some embodiments, the network device 120 may transmit DL data with the indication to the terminal device 110. So far, the initial transmission is done.

Based on the indication, the terminal device 110 may transmit 213 further UL data and BSR to the network device 120, for example, based on a dynamic grant or configured grant. Then the network device 120 may transmit 214 an UL grant for dynamic grant to the terminal device 110. In some embodiments, the network device 120 may transmit DL data with the UL grant to the terminal device 110. Based on the UL grant from the network device 120, the terminal device 110 may transmit 215 remaining UL data to the network device 120. Accordingly, the network device 120 may transmit 216 RRC release message to the terminal device 110. So far, subsequent transmission is done. That is, the SDT procedure 200B ends. It is to be understood that the SDT procedure 200B may comprise more or less steps in the subsequent transmission.

### Example Implementation of Handling RRC Reject During SDT

As explained above, during SDT procedure, the terminal device 110 in inactive state may transmit to the network device 120 UL data together with one RRC Resume Request message. The network device 120 may respond to terminal device 110 an RRC Reject message, for example due to network congestion. However, the behavior of terminal device 110 upon the reception of the RRC Reject message is not clear. In view of this, embodiments of the present disclosure propose proper behavior performed by terminal device 110 upon or after reception of RRC Reject message during one SDT procedure.

FIG. 3 illustrates a schematic diagram illustrating a process 300 for communication according to embodiments of the present disclosure. For the purpose of discussion, the process 300 will be described with reference to FIG. 1A. The process 300 may involve the terminal device 110 and the network device 120 as illustrated in FIG. 1A. The network device 120 may be a last serving network device or new network device for the terminal device 110. While the terminal device 110 is performing a first RRC resume procedure initiated for SDT, one connection rejection message can be received from the network device 120, for example RRC Reject message. After receiving the RRC Reject message, the terminal device 110 may terminate the SDT procedure and remain at inactive state, and initiate a second RRC resume procedure.

As shown in FIG. 3, the terminal device 110 is performing a first RRC resume procedure initiated for SDT, and receives 310 from the network device 120 a connection rejection message, for example RRC Reject message. In some embodiments, after receiving the RRC reject message, the terminal device 110 discards 311 the buffered packets in the PDCP entities and RLC entities of the radio bearers configured with SDT. For example, the terminal device 110 may perform PDCP SDU discard for the SRB configured with SDT, wherein buffered PDCP SDUs and PDCP PDUs are discarded. As another example, the terminal device 110 may perform RLC re-establishment for the radio bearer configured with SDT. In this way, the buffered data can be discarded before a subsequent second RRC resume procedure, therefore an accurate data volume can be obtained by the terminal device 110 to determine whether SDT procedure can be triggered or not for the second RRC resume procedure.

Currently, during MAC reset procedure, all the time alignment timers are considered as expiry. And upon an alignment timer for SDT is expiry, the terminal device shall discard the configured grant resource for SDT. In some embodiments, after receiving the RRC Reject message, the terminal device 110 performs 312 MAC reset procedure, and the configured grant resource for SDT is maintained during the MAC reset procedure. For example, during MAC reset procedure, the terminal device 110 considers all time alignment timers as expired. However, the terminal device 110 maintains the configured grant used for SDT upon the expiry of time alignment timer. In other words, upon expiry of time alignment timer, terminal device 110 only discards configured grant not configured for SDT. For another example, during the MAC reset procedure, the terminal device 110 maintains the time alignment timer for SDT, in other words the terminal device 110 does not consider the timer alignment timer as expiry. In this way, the configured grant resource for SDT can be maintained and used for the second RRC resume procedure.

If the second RRC resume procedure is initiated in the same cell, the same security keys would be generated and the terminal device 110 may use same security and same PDCP count value to cipher different packets. This is called security key stream reuse issue which is not allowed.

In some embodiments, to avoid the security key stream reuse issue, horizontal security key change can be performed by the terminal device 110. In some embodiments, after receives RRC Reject message from the network device 120 during one SDT procedure, the terminal device 110 initiates 320 a second RRC resume procedure. For example, the second RRC resume procedure can be an SDT procedure or a legacy RRC resume procedure. In some embodiments, the terminal device 110 performs 321 horizontal key derivation to obtain the keys to be used in a second RRC Resume procedure. In this way, the security key to be used for the second RRC Resume procedure would be different from the first RRC Resume procedure, thus the security key stream reuse issue would be solved.

In some embodiments, during the second RRC Resume procedure, the terminal device 110 transmits 322 the buffered/old data in the PDCP entity. For example, when performing PDCP re-establishment for the SRB configured with SDT, the terminal device 110 maintains the PDCP SDUs in the PDCP entity. In other words, the PDCP SDUs is not discarded during the PDCP re-establishment for SRBs configured with SDT during the second RRC Resume procedure. And the buffered PDCP PDUs for the SRBs will be transmitted during the second RRC Resume procedure. For another example, for UM DRBs configured with SDT, the terminal device 110 perform transmission of the PDCP SDUs for which have previously been submitted to lower layers (e.g. RLC, MAC and PHY layer) during the PDCP re-establishment of the second RRC resume procedure. In other words, for UM DRBs configured with SDT, not only the PDCP SDUs which have previously not been submitted to lower layers, PDU which have previously been submitted to lower layers are also transmitted during the PDCP re-establishment of the second RRC resume procedure. In this way, the buffered data not able to be transmitted successfully during the first RRC resume procedure for SDT, can be retransmitted during the second RRC resume procedure.

In some embodiments, to avoid the security stream reuse issue, the terminal device 110 may initiate a RRC setup procedure, or the second RRC resume procedure initiated by the terminal device 110 shall be a legacy RRC resume procedure. In some embodiments, after receiving the RRC Reject message from the network device 120 during one SDT procedure, the terminal device 110 should 331 avoid initiating a second RRC Resume procedure which will generate same security key and same PDCP count value (as used in the previous SDT procedure) to cipher different packets. For example, in case that the terminal device 110 determines that different PDCP packets will be transmitted using same PDCP count value and same security key as used in the previous SDT procedure, terminal device 110 transitions to IDLE state, and then initiates one RRC setup procedure. As another example, in case that the terminal device 110 determines that PDCP packets will be transmitted using same PDCP count value and same security key as used in the previous SDT procedure, the terminal device 110 initiates a legacy RRC resume procedure, which means no UL data is transmitted together with the RRC Resume Request message. And the network device 120 transmits 332 RRC setup message to the terminal device. Or the network device 120 transmits 332 RRC resume message comprising key update configuration. In this way, the security key stream reuse issue can be solved.

### Example Implementation of Handling of RRC Reject in Response to Non-SDT Indication

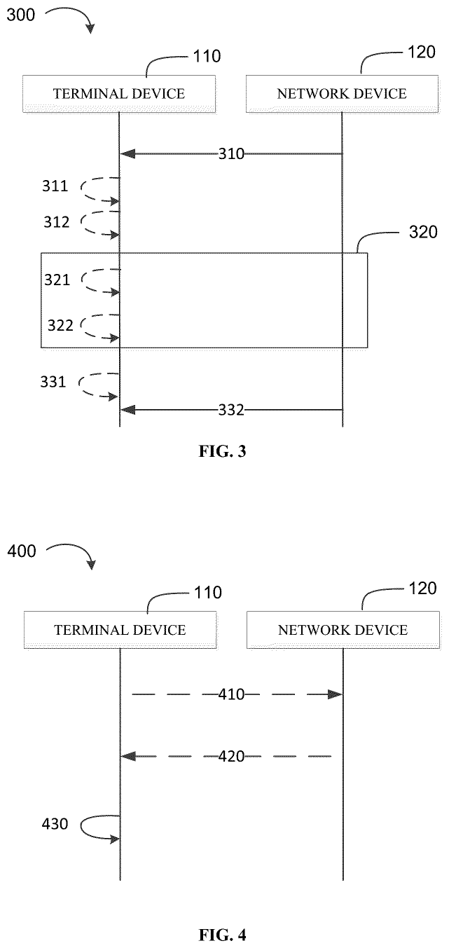

FIG. 4 illustrates a schematic diagram illustrating a process 400 for communication according to embodiments of the present disclosure. For the purpose of discussion, the process 400 will be described with reference to FIG. 1A. The process 400 may involve the terminal device 110 and the network device 120 as illustrated in FIG. 1A. The network device 120 may be a last serving network device or new network device for the terminal device 110.

As shown in FIG. 4, upon initialization of one SDT procedure, the terminal device 110 starts a timer for failure detection of the SDT procedure. And during the SDT procedure, new uplink data from radio bearers not supporting SDT (i.e., non-SDT data) may arrive. The terminal device 110 may send 410 message using SRB1 to indicate the arriving of non-SDT data to the network device 120. And the network device 120 may send 420 one RRC reject message to the terminal device 110. Upon reception of the RRC reject message, the terminal device 110 continues 430 the SDT procedure. In some embodiments, upon reception of RRC Reject message, the terminal device 110 determine if the timer for SDT is running. If the timer is not running, the terminal device 110 resets MAC and releases the default MAC Cell Group configuration, discards the security keys, suspends SRB1, and informs upper layers about the failure to resume the RRC connection. If the timer is running, the terminal device 110 informs upper layers about the failure to resume the RRC connection. Here, the failure to resume the RRC connection is corresponding to the non-SDT data.

In this way, the on-going SDT is not interrupted due to reception of RRC reject message in response to the non-SDT data arrival indication. And the data loss and service interruption can be avoided.

### Example Implementation of Handling of No Valid CG-SDT Resource

Currently, at least one Synchronization Signal Block (SSB) is associated with one CG resource for SDT. After CG-SDT procedure is triggered, if Synchronization Signal Reference Signal Received Power (SS-RSRP) of at least one SSB associated with the CG resources for SDT is above a threshold, the terminal device 110 considers that there are qualified configured grant to be used for the SDT procedure. Otherwise, it means that there are no qualified configured grant to be used for SDT. If terminal device 110 initiates random access (RA) procedure every time there is no qualified configured grant, it leads to frequent triggering of random access procedure. In embodiments of the present disclosure, solutions on how to avoid this frequent RA triggering are provided.

In some embodiments, the terminal device 110 determines that there are no SSB associated with the CG resources for SDT is above the threshold, and determines that the BSR is triggered, the terminal device 110 initiates a random access procedure. In some embodiments, the terminal device 110 determines that there are no SSB associated with the CG resources for SDT is above the threshold, and determines that there is buffered data to be transmitted, the terminal device 110 initiates a random access procedure. In this way, there is no need to trigger random access procedure every time when there is no qualified CG resource for SDT. During CG-SDT procedure, the legacy time alignment timer (i.e. time alignment timer not used for SDT) is expired and not running. In some embodiments, during CG-SDT procedure, the terminal device 110 receives RRC resume message or RRC setup message from the network device. The RRC layer of the terminal device 110 shall indicate to the MAC layer of the terminal device 110 to start or restart the legacy time alignment timer. And upon the MAC layer of terminal device 110 receives the indication from RRC layer of the terminal device 110, the terminal device 110 shall start or restart the legacy time alignment timer. In this way, the legacy time alignment timer can start running for a connected state terminal device.

### Example Implementation of Methods

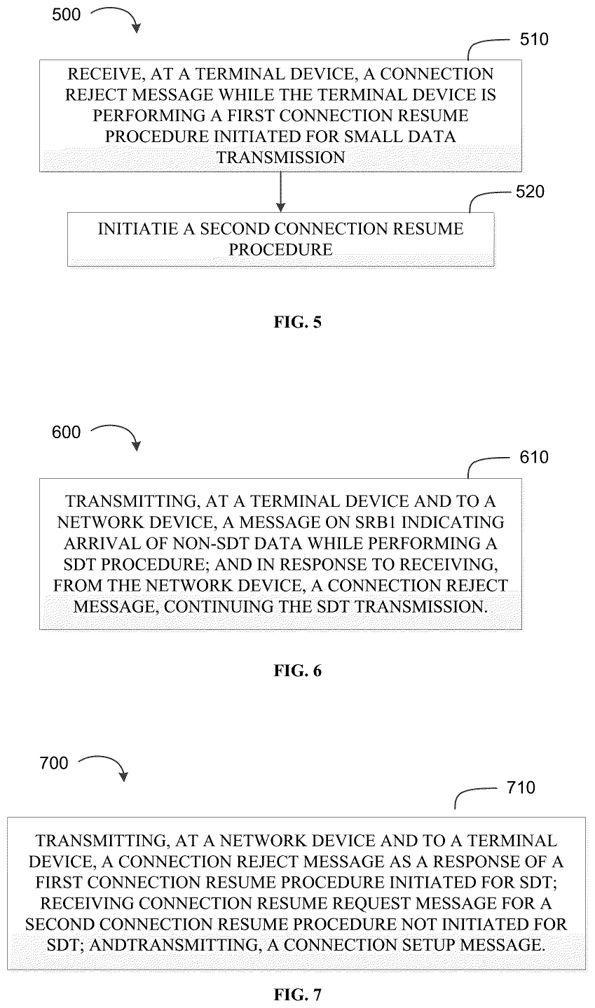

Accordingly, embodiments of the present disclosure provide methods of communication implemented at a terminal device. These methods will be described below with reference to FIGS. 5 to 7.

FIG. 5 illustrates an example method 500 of communication implemented at a terminal device in accordance with some embodiments of the present disclosure. For example, the method 500 may be performed at the terminal device 110 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the terminal device 110 receives, from a network device 120, a connection reject message while the terminal device is performing a first connection resume procedure initiated for SDT. In some embodiments, in response to receiving the connection reject message, the terminal device 110 discards the buffered packets for the radio bearers configured with SDT. In some embodiments, the terminal device 110 performs PDCP SDU discard for the SRB configured with SDT. In some embodiments, in response to receiving the connection reject message, the terminal device 110 MAC reset procedure, and configured grant resource for SDT is maintained during the MAC reset procedure.

At block 520, the terminal device 120 initiates a second connection resume procedure. In some embodiments, the terminal device performs horizontal key derivation to obtain the security key to be used during the second connection resume procedure. In some embodiments, the terminal device 110 transmits the buffered packets in PDCP entity for the radio bearer configured with SDT. In some embodiments, the terminal device 110 maintains the PDCP SDUs for the SRB configured with SDT during the PDCP re-establishment procedure. In some embodiments, the terminal device 110 performs transmission of the PDCP SDUs for the (Unacknowledged Mode) UM DRB configured with SDT which have previously been submitted to lower layers. n some embodiments, the terminal device 110 determines that different packet maybe transmitted using same security key and same PDCP count value as used in the first connection resume procedure initiated for SDT, and goes to idle state and initiating connection setup procedure or initiates the second connection resume procedure without UL data transmitted during inactive state.

FIG. 6 illustrates an example method 600 of communication implemented at a terminal device in accordance with some embodiments of the present disclosure. For example, the method 600 may be performed at the terminal device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the terminal device 110 transmits, to network device 120, a message on SRB1 indicating arrival of non-SDT data while performing a SDT procedure; and in response to receiving, from the network device, a connection reject message, the terminal device 110 continues the SDT transmission.

FIG. 7 illustrates an example method 700 of communication implemented at a network device in accordance with some embodiments of the present disclosure. For example, the method 700 may be performed at the network device 120 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the network device 120 transmits, to terminal device 110, a connection reject message as a response of a first connection resume procedure initiated for SDT; receiving connection resume request message for a second connection resume procedure not initiated for SDT; and transmitting, a connection setup message.

FIG. 8 illustrates an example method 800 of communication implemented at a terminal device in accordance with some embodiments of the present disclosure. For example, the method 800 may be performed at the network device 120 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the terminal device 110 initiates a configured grant based SDT procedure; determining that there is no SSB associated with the configured grant resources for SDT is above the threshold; determining that the BSR is triggered or there is buffered data to be transmitted; and initiating a random access procedure.

### Example Implementation of Device

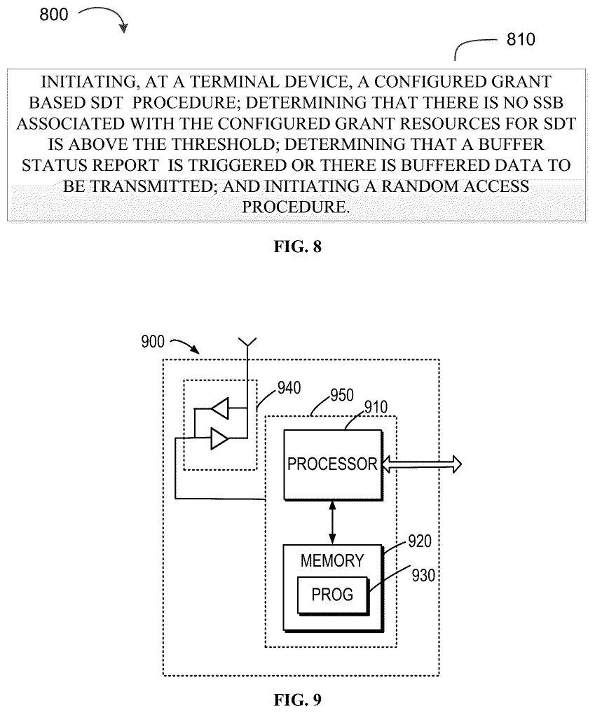

FIG. 9 is a simplified block diagram of a device 900 that is suitable for implementing embodiments of the present disclosure. The device 900 can be considered as a further example implementation of the terminal device 110 or the network device 120, as shown in FIG. 1. Accordingly, the device 900 can be implemented at or as at least a part of the terminal device 110 or the network device 120 or 130.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the cNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, the circuitry comprises circuitry configured to: from a network device, a connection reject message while the terminal device is performing a first connection resume procedure initiated for SDT; and initiate a second connection resume procedure.

In some embodiments, the circuitry may be further configured to: in response to receiving the connection reject message, discard the buffered packets for the radio bearers configured with SDT.

In some embodiments, the circuitry may be further configured to perform PDCP SDU discard for the signalling radio bearer configured with SDT.

In some embodiments, the circuitry may be further configured to: in response to receiving the connection reject message, perform MAC reset procedure; and maintain configured grant resource for SDT during the MAC reset procedure.

In some embodiments, the circuitry may be further configured to initiate a second connection resume procedure by performing horizontal key derivation to obtain the security key.

In some embodiments, the circuitry may be further configured to initiate the second connection resume procedure, and transmit the buffered packets in PDCP entity for the radio bearer configured with SDT.

In some embodiments, the circuitry may be further configured to maintain the PDCP SDUs for the SRB configured with SDT during the PDCP re-establishment procedure; or perform transmission of the PDCP SDUs which have previously been submitted to lower layers for the UM DRB configured with SDT.

In some embodiments, the circuitry may be further configured to determine that different packet maybe transmitted using same security key and same PDCP count value as used in the first connection resume procedure initiated for SDT; and perform at least one of the following: go to idle state and initiating connection setup procedure; or initiate the second connection resume procedure without UL data transmitted during inactive state.

In some embodiments, a terminal device comprises circuitry configured to: transmit, to a network device, a message on SRB1 indicating arrival of non-SDT data while performing a SDT procedure; receive, from the network device, a connection reject message; and continue the SDT transmission.

In some embodiments, the circuitry may be further configured to determine one timer for SDT failure detection is running; and inform upper layers about the failure to resume the RRC connection.

In some embodiments, a network device comprises circuitry configured to: transmit, at a network device and to a terminal device, a connection reject message as a response of a first connection resume procedure initiated for SDT; receive connection resume request message for a second connection resume procedure not initiated for SDT; and transmit, a connection setup message.

In some embodiments, a terminal device comprises circuitry configured to: Initiate, at a terminal device, a configured grant based SDT procedure; determine that there is no SSB associated with the configured grant resources for SDT is above the threshold; determine that a Buffer Status Report (BSR) is triggered or there is buffered data to be transmitted; and initiate a random access procedure.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-16. (canceled)

17. A method performed by a terminal device, the method comprising:
determining whether there is data for transmission for at least one radio bearer configured for small data transmission (SDT), in response to no synchronization signal block (SSB) configured for configured grant (CG)-SDT with synchronization signal reference signal received power (SS-RSRP) above a threshold, when CG-SDT is triggered; and
initiating a random access procedure in response to determining that there is data for transmission for at least one radio bearer configured for SDT.

18. The method of claim 17, further comprising:
performing service data unit (SDU) discard for signalling radio bearer (SRB) configured with SDT by a packet data convergence protocol (PDCP) entity, in response to a radio resource control (RRC) reject message being received and a resume procedure being initiated for SDT.

19. The method of claim 17, further comprising:
receiving a RRC resume message or a RRC setup message; and
instructing a media access control (MAC) entity of the terminal device to start a time alignment timer, in response to the time alignment timer being not running.

20. The method of claim 17, further comprising:
considering configured grant for the CG-SDT as valid, in response to an SSB configured for CG-SDT with SS-RSRP above a threshold, when the CG-SDT is triggered.

21. A terminal device comprising a processor configured to cause the terminal device to:
determine whether there is data for transmission for at least one radio bearer configured for small data transmission (SDT), in response to no synchronization signal block (SSB) configured for configured grant (CG)-small data transmission (SDT) with synchronization signal reference signal received power (SS-RSRP) above a threshold, when CG-SDT is triggered; and
initiate a random access procedure in response to determining that there is data for transmission for at least one radio bearer configured for SDT.

22. The terminal device of claim 21, wherein the processor is further configured to cause the terminal device to:
perform service data unit (SDU) discard for signalling radio bearer (SRB) configured with SDT by a packet data convergence protocol (PDCP) entity, in response to a radio resource control (RRC) reject message being received and a resume procedure being initiated for SDT.

23. The terminal device of claim 21, wherein the processor is further configured to cause the terminal device to:
receive a RRC resume message or a RRC setup message; and
instruct a media access control (MAC) entity of the terminal device to start a time alignment timer, in response to the time alignment timer being not running.

24. The terminal device of claim 21, wherein the processor is further configured to cause the terminal device to:
consider configured grant for the CG-SDT as valid, in response to an SSB configured for CG-SDT with SS-RSRP above a threshold, when the CG-SDT is triggered.
